(19) United States
(12) Patent Application Publication
(10) Pub. No.: US 2009/0191372 A1
(43) Pub. Date: Jul. 30, 2009

(54) METHOD AND APPARATUS FOR APPLYING GRAPHIC DESIGNS TO VEHICLES

(76) Inventor: Cullen P. Raichart, San Diego, CA (US)

Correspondence Address: Mr. Walter J. Tencza Jr., Suite 210, 100 Menlo Park, Edison, NJ, 08837, US

(21) Appl. No.: 12/019,443

(22) Filed: Jan. 24, 2008

(51) Int. Cl. B32B 33/00; B05D 5/10

(52) U.S. Cl. 428/41.7; 428/343; 428/337; 428/220; 427/147

(57) ABSTRACT

In at least one embodiment of the present invention, an apparatus is provided including a a sticker for adhering to a vehicle surface. The sticker may include an automotive clear coat, a paint, a base or substrate, and an adhesive. The automotive clear coat lies on top of the paint, the paint lies on top of the base, and the base lies on top of the adhesive. The sticker can be adhered to the vehicle surface by use of the adhesive.

### FIELD OF THE INVENTION

This invention relates to improved methods and apparatus concerning applying graphic designs to vehicles.

### BACKGROUND OF THE INVENTION

There are various devices known in the prior art for applying graphic designs to vehicles.

### SUMMARY OF THE INVENTION

In at least one embodiment of the present invention, an apparatus is provided including a sticker for adhering to a vehicle surface. The sticker may include an automotive clear coat, a paint, a base or substrate, and an adhesive. The automotive clear coat lies on top of the paint, the paint lies on top of the base, and the base lies on top of the adhesive. The sticker can be adhered to the vehicle surface by use of the adhesive.

The automotive clear coat may include a clear coat and a flex agent. The base may be comprised of a clear vinyl or clear nylon. The paint may be an automotive paint. The adhesive may be a removable pressure sensitive adhesive.

The apparatus may further include a backing. The backing may be attached to the adhesive and can be removed from the adhesive to allow the sticker to be adhered to the vehicle surface. The base, the adhesive, and the backing may be part of a product known in the art called MacTac (trademarked), MACScreen (trademarked), MACal 8199R.

The combination of the base and the adhesive may have a thickness of about three millimeters. The adhesive is a removable adhesive. The base may be a cadmium-free vinyl. The adhesive may be high performance, removable, acrylic pressure sensitive adhesive. The backing may be a 86# white kraft liner.

In at least one embodiment of the present invention, a method is provided including preparing a sticker for adhering to a vehicle surface, the sticker having one or more of the components and/or configurations previously mentioned.

### BRIEF DESCRIPTION OF THE DRAWINGS

FIG. 1 shows a simplified block diagram of an apparatus for applying a graphic design in accordance with the present invention;

FIG. 2 shows a simplified block diagram of a portion of the apparatus of FIG. 1 applied to a surface of a vehicle in accordance with an embodiment of the present invention;

FIG. 3 shows a simplified block diagram of the apparatus of FIG. 1, with the apparatus shown divided or cut into multiple sections or pieces.

### DETAILED DESCRIPTION OF THE DRAWINGS

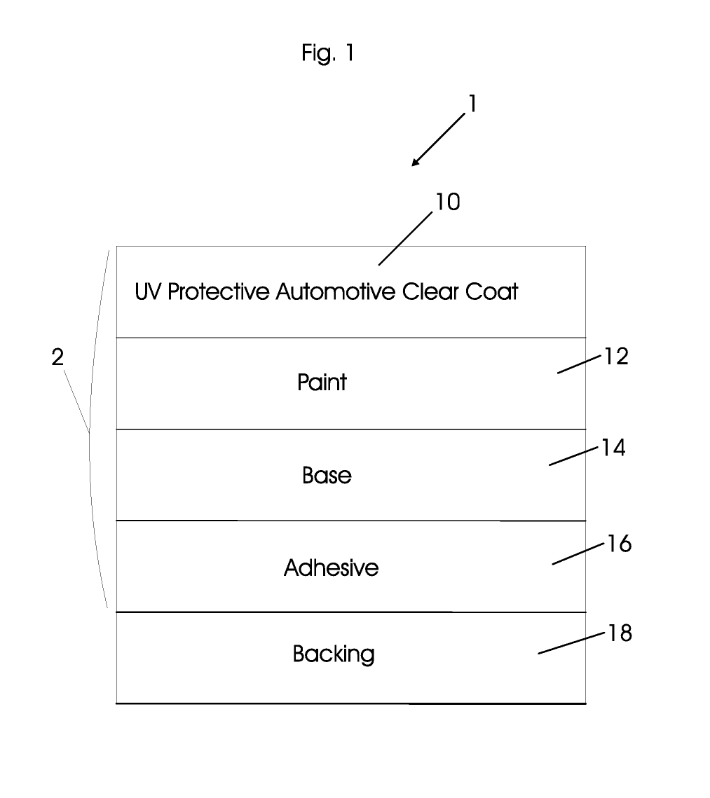

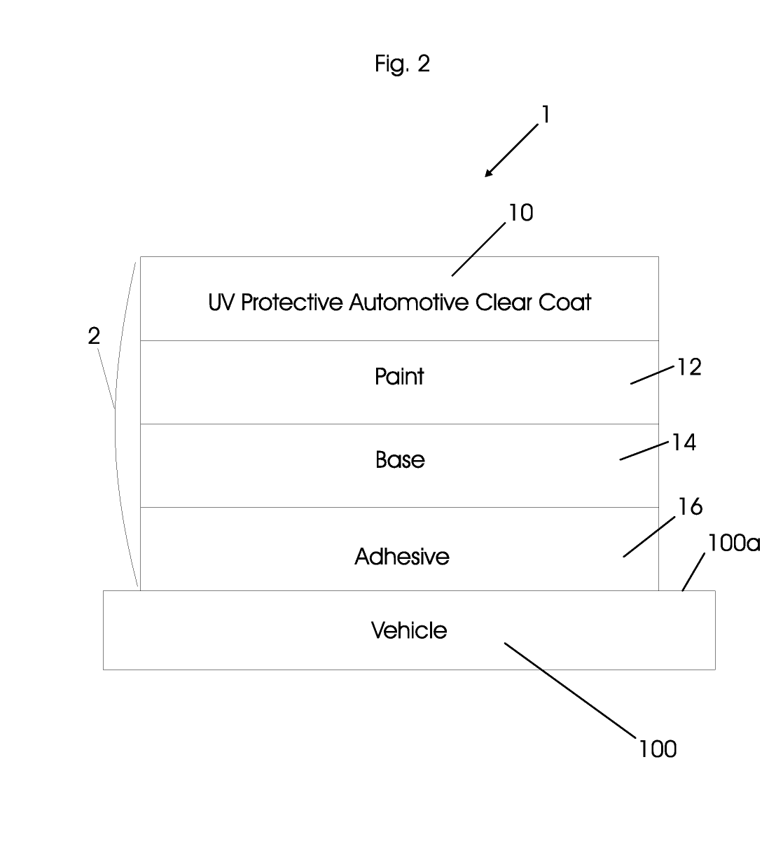

FIG. 1 shows a simplified block diagram of an apparatus 1 for applying a graphic design in accordance with the present invention. FIG. 2 shows a simplified block diagram of a portion or sticker 2 of the apparatus 1 of FIG. 1 applied to a surface 100a of a vehicle 100 in accordance with an embodiment of the present invention.

Referring to FIG. 1, the apparatus 1 includes an ultraviolet protective automotive clear coat 10, a paint 12, a base 14, an adhesive 16, and a backing 18. The automotive clear coat 10 may include an automotive clear coat and a flex agent that allows the apparatus 1 (not including the backing 18), to remain flexible when being applied to a vehicle surface, such as surface 100a shown in FIG. 2. The base or substrate 14 may be made of clear vinyl or clear nylon. The paint 12 may be an automotive paint, such as any brand or color of automotive paint. The adhesive 16 may be a removable pressure sensitive adhesive. The combination of the base or substrate 14, the adhesive 16, and the backing 18 may be a product called MacTac (trademarked). The backing 18 may be a paper backing.

The automotive clear coat 10 and the paint 12 may include PPG Industries' Deltron (trademarked) 2000 (DBC) Basecoat and DC4000 Clearcoat which is currently a state-of-the-art, premium quality basecoat/clearcoat system designed to reproduce the hi-tech O.E.M. finishes found on today's import and domestic vehicles. The DBC initials are product codes used by PPG. The DBC is a basecoat that is part of a two part paint system (basecoat/clearcoot) the other part number is a DC 4000 which is a clear coat.

MacTac (trademarked) or a version of MacTac (trademarked), such as MAC screen (trademarked) MACal 8199R, as used in one embodiment of the present invention, can include three mill clear calendered vinyl film (for base 14) coated on one side with a high performance, removable, acrylic pressure sensitive adhesive (for adhesive 16). The liner (for backing 18) may be an 86# white kraft that provides excellent layflat and may be backprinted. In the prior art Mac Tac (trademarked) is used for screen-printed labels, decals, markings, point-of-purchase displays and signs for indoor and outdoor use. The thickness of the film or base 14 plus the adhesive 16 may be 0.0040 inches or 0.101 millimeters. A version of MacTac (trademarked), such as MACal 8199R, as used in one embodiment of the present invention is cleanly removable for up to one year after application on most surfaces. However, some surfaces, such as acrylic glass, polystyrene, nitrocellulose painted surfaces and soft PVC (polyvinyl chloride) may leave a slight residue or increase in adhesion over time.

In another embodiment of the present invention, a permanent version of MacTac (trademarked) can be used such as MACscreen® MACal 9800P, which is designed for high performance permanent marking applications. In this permanent embodiment, the base 14 can be a 2.8-millimeter cadmium-free vinyl, which is durable yet, highly flexible for conformability over difficult surfaces and has an enhanced high gloss finish. A high performance, permanent, clear acrylic adhesive for the adhesive 16. A 86# white kraft liner for the backing 18 for excellent stability and layflat during the screen printing process. The thickness of the film or base 14 plus adhesive 16 may be 0.0047 Inches or 0.120 millimeters.

The portion or sticker 2, which can be called a “Cycle-Tat” in one embodiment, can include, a customizable vehicle graphic that once applied is indistinguishable from an actual custom paint job, such as a custom paint job on a vehicle, such as a car or motorcycle. After the portion or sticker 2 of the apparatus 1, not including backing 18, has been applied to a vehicle surface, such as surface 100a as shown in FIG. 2, the portion or sticker 2 applied, is washable, waxable and completely removable from the vehicle surface 100a and reusable. The portion or sticker 2 adhered to the vehicle surface 100a, leaves no residue and does not affect the underlying surface 100a in anyway.

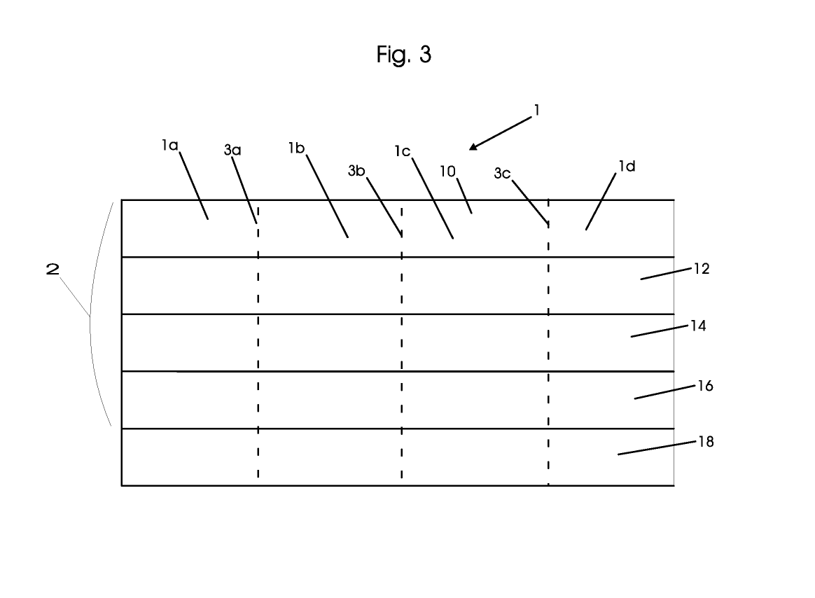

The apparatus 1 can be laid out in sheets, and cut into various set designs and or shapes, using a die cutting process. The apparatus 1 can also be custom cut using a commercially available vinyl sign cutter. FIG. 3 shows a simplified block diagram of the apparatus 1 of FIG. 1, with the apparatus 1 shown cut along dashed lines 3a, 3b, and 3c, in order to cut the apparatus 1 into sections or pieces 1a, 1b, 1c, and 1d.

The apparatus 1 may be in the form of a sticker 2 with a backing 18. The backing 18 is removed and the graphic or remaining portion or sticker 2 of the apparatus 1 is applied directly to a clean dry surface, such as surface 100a shown in FIG. 2. Large graphics may be applied using industry standard vinyl sign application techniques, which are known in the art. Removal of the portion or sticker 2 (not including the backing 18) from the surface 100a can be done by simply peeling off the portion or sticker 2 (not including the backing 18). The removed sticker, such as 2, can then be placed on a clean smooth surface for use later.

While the adhesive 16 in one embodiment is a temporary adhesive allowing the portion or sticker 2 to be removed, in another embodiment the adhesive 16 may be permanent and may not be removable from the surface 100a of the vehicle 100.

The following is a paint application description (that applies to the Deltron 2000 (DBC) (trademarked) paint product): The substrate 14 is prepared by removing any dust or other particles and this is typically accomplished with the use of de-ionized water and a squeegee. The surface of the substrate 14 is first sprayed with de-ionized water, then the water is removed using a squeegee the resulting surface of the substrate 14 is clean and particle free. The painting process starts with the Base coat 12.

The DBC is reduced by 100% with a DT (Deltron Thinner) reducer best suited to shop temperature and size of job, to form a modified base coat for base coat 12.

Next a 5% DX57 hardener is added to the modified base coat 12 to form a further modified base coat 12. This further modified base coat 12 is applied with a spray gun to Substrate 14.

The spray gun may have settings for fluid tip: 1.0-1.4 mm (millimeters) or equivalent, air pressure eight to ten PSI (pounds per square inch) at the cap for HVLP (High Volume Low Pressure) guns. Thirty-five to forty-five PSI at the gun for conventional guns.

Two to three coats of the further modified base coat 12 is applied to the substrate 14 until hiding is achieved. Thick films of DBC should be avoided. Drying time of ten to fifteen minutes should be allowed between coats of further modified base coat 12.

Drying time of 10 to fifteen minutes for the further modified base coat 12 should be allowed before the clear coat 10 is placed on. The clear coat 10 is a final stage to be applied. The clear coat 10 may be a mixture of four parts of Deltron Clear coat (DC4010) one part of Deltron Clear coat Hardener (DCH), and ½ part of Flexibilizer (DX814).

The clear coat 10 can be sprayed on with a spray gun having settings of tip 1.3-1.5 millimeters, mm or equivalent pressure for HVLP guns at the air cap. Conventional guns forty-five to fifty-five PSI at the spray gun. Two wet coats of DC4010 clear coat should be applied to the Basecoat 12, to form layer 10. The drying time between the two wet coats of clear coat 10 should be five to seven minutes between coats and four to six hours to complete cure.

In one embodiment, the existing substrate or base 14, adhesive 16, and backing 18, such as Mac Tac, (trademarked), is cleaned then painted with an automotive paint system. The automotive paint system may have two stages such as a basecoat and a clear coat; a single stage such as a basecoat only; or three stages such as a basecoat, color coat, and a clear coat. This automotive paint system or painting process may be applied only to the substrate 14. Once cured this can be called the “Cycle-Tat”. The next step may be an application which is known in the art. Typically, in accordance with an embodiment of the present invention, no paint is applied to anything aside from the substrate 14 or subsequent layers of basecoat or paint 12.

In accordance with one embodiment of the present invention, the combination of automotive finish/paint and a pliable removable medium such as MacTac (trademarked) that is unique. In one embodiment this can be called a removable customizable vehicle finish. A user is not stuck with a paint job but rather can switch easily and affordably.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising
a sticker for adhering to a vehicle surface, the sticker comprising
an automotive clear coat;
a paint;
a base; and
an adhesive;
and wherein the automotive clear coat lies on top of the paint, the paint lies on top of the base, and the base lies on top of the adhesive;
and wherein the sticker can be adhered to the vehicle surface by use of the adhesive.

2. The apparatus of claim 1 wherein
the automotive clear coat includes a clear coat and a flex agent.

3. The apparatus of claim 1 wherein
the base is comprised of clear vinyl.

4. The apparatus of claim 1 wherein
the base is comprised of clear nylon.

5. The apparatus of claim 1 wherein
the paint is an automotive paint.

6. The apparatus of claim 1 wherein
the adhesive is a removable pressure sensitive adhesive.

7. The apparatus of claim 1 further comprising
a backing;
and wherein the backing is attached to the adhesive and can be removed from the adhesive to allow the sticker to be adhered to the vehicle surface.

8. The apparatus of claim 7 wherein
the base, the adhesive, and the backing are part of MacTac(trademarked), MACScreen (trademarked), MACal 8199R.

9. The apparatus of claim 1 wherein
the base has a thickness of about three millimeters.

10. The apparatus of claim 1 wherein
a combination of the base and the adhesive has a thickness of about 0.004 inches.

11. The apparatus of claim 1 wherein
the adhesive is a permanent adhesive.

12. The apparatus of claim 1 wherein
a combination of the base and the adhesive has a thickness of about 0.0047 inches.

13. The apparatus of claim 1 wherein
the base is a cadmium-free vinyl.

14. The apparatus of claim 1 wherein
the adhesive is a high performance permanent clear acrylic adhesive.

15. The apparatus of claim 7 wherein
the backing is a white kraft liner.

16. A method comprising
preparing a sticker for adhering to a vehicle surface, the sticker comprising
an automotive clear coat;
a paint;
a base; and
an adhesive;
and wherein the automotive clear coat lies on top of the paint, the paint lies on top of the base, and the base lies on top of the adhesive;
and wherein the sticker can be adhered to the vehicle surface by use of the adhesive.

17. The method of claim 16 wherein
the automotive clear coat includes a clear coat and a flex agent.

18. The method of claim 16 wherein
the base is comprised of clear vinyl.

19. The method of claim 16 wherein
the base is comprised of clear nylon.

20. The method of claim 16 wherein
the paint is an automotive paint.

21. The method of claim 16 wherein
the adhesive is a removable pressure sensitive adhesive.

22. The method of claim 16 further comprising
a backing;
and wherein the backing is attached to the adhesive and can be removed from the adhesive to allow the sticker to be adhered to the vehicle surface.

23. The method of claim 22 wherein
the base, the adhesive, and the backing are part of MacTac(trademarked), MACScreen (trademarked).

24. The method of claim 16 wherein
the base has a thickness of about three millimeters.

25. The method of claim 16 wherein
a combination of the base and the adhesive has a thickness of about 3 millimeters.

26. The method of claim 16 wherein
the adhesive is a permanent adhesive.

27. The method of claim 16 wherein
the base has a thickness of about 2.8 millimeters.

28. The method of claim 16 wherein
the base is a cadmium-free vinyl.

29. The method of claim 16 wherein
the adhesive is a high performance permanent clear acrylic adhesive.

30. The method of claim 22 wherein
the backing is a white kraft (trademarked) liner.
